(19) United States
(12) Patent Application Publication
(10) Pub. No.: US 2003/0154321 A1
(43) Pub. Date: Aug. 14, 2003

(54) Method and system for registering a control within an operating environment using a control manager

(75) Inventors: Kenneth C. Wyke, Culpeper, VA (US); John Moore, Falls Church, VA (US); Archie Spivey, Myrtle Beach, SC (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Lockheed Martin Corporation

(21) Appl. No.: 10/321,385

(22) Filed: Dec. 18, 2002

Related U.S. Application Data
(60) Provisional application No. 60/341,862, filed on Dec. 21, 2001.

(51) Int. Cl. G06F 9/00

(52) U.S. Cl. 709/320

(57) ABSTRACT

A system and method for registering software controls within a secure operating environment is disclosed. The software controls reside within the operating environment in coordination with a control manager. The manager facilitates registration and authorization of new controls. The manager detects that new control has been placed within the operating environment. The manager reads the type of the control. The manager initiates an encode/decode sequence with the control. A key string is exchanged and modified between the manager and the control. Preferably, a random number is generated and added to the key string by the manager. The manager reads the result of the encode/decode sequence from the control. If the result is acceptable, then the manager adds the control to its control list and plumbs all of the controls within the operating environment. If the result is not acceptable, the manager ignores or shutdowns the control.

### CROSS REFERENCE TO RELATED APPLICATIONS

This application claims benefit of U.S. Provisional Patent Application No. 60/341,862 entitled “Electronic Interactive Communication System and the Method Therefor,” filed Dec. 21, 2001, which is hereby incorporated by reference.

### BACKGROUND OF THE INVENTION

1. Field of the Invention

The present invention relates to an electronic interactive communication system, and, more particularly, the invention relates to a system and method for registering and coordinating software controls with a manager within a secure operating environment.

2. Discussion of the Related Art

The number of computing platforms has markedly increased in recent years. Palm-size and/or portable computing devices have become commonplace. Further, the number of different versions of a particular platform has increased as well, each with specific operating systems. A variety of software programs also has been created to execute on the computing platforms. Conventional computing devices can pre-store information and program code in memory or receive the information from another device to enable executing the programs. With the multitude of computing platforms and operating systems, programs and information should be conceived with the ability to execute in many operating environments.

A software control may enable or launch different programs operating on different platforms. A software control may be a program module that enhances the functionality of an existing program. A control may act as a user interface function that allows the user to manipulate information stored in the memory of a computing platform. Controls may add functionality by calling existing components to integrate and appear as normal parts of the program. In general, however, these controls are dormant until activated and may not reside passively within a computing environment. This drawback may reduce the effectiveness of the controls and restrict the ability of the controls to interact within the software environment, and with other programs and controls. Further, conventional controls may not access the properties and methods of other controls without causing that control to become active.

Controls may be desirable on computing platforms that are portable devices, as discussed above. The controls may improve the functionality of the portable device and provide the user with additional information over programs stored on the device. Problems, however, may occur if the computing platform includes secure or proprietary information, programs, applications, or controls. Further, a secure operating environment does not desire to accept controls that may compromise the operation of the applications or programs. Controls downloaded or “dropped” into the secure operating environment may cause damage to other controls, the operating environment, applications, and the like.

### SUMMARY OF THE INVENTION

Accordingly, the disclosed embodiments are directed to a system and method that enables a manager to register software controls within an operating environment.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, according to the disclosed embodiments, a system for registering software controls within and operating environment is disclosed. The system includes a new control placed into the operating environment. The system also includes a software control manager to identify the new control. The system also includes an encode/decode sequence to determine a type for the new control. The manager authorizes the new control according to the type.

According to the disclosed embodiments, a method for registering a control in an operating environment coupled to a memory. The memory stores data. The method includes initiating an encode/decode sequence from a manager to the control within the operating environment. The method also includes reading a result of the sequence from the control. The method also includes allowing the control to operate within the operating environment according to the result.

According to the disclosed embodiments, a method for accepting a control by a control manager is disclosed. The method includes receiving a key string at the manager from the control. The method also includes modifying the key string according to the manager. The method also includes receiving the modified key string at the control. The method also includes reading the modified key string from the control.

According to the disclosed embodiments, a method for registering a control within an operating environment is disclosed. The method includes detecting the control at a manager within the operating environment. The method also includes modifying a key string from the control at the manager. The method also includes adding the control to a control list within the manager if the modified key string is acceptable. The method also includes plumbing other controls within the operating environment by the manager.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the drawings:

FIG. 1 depicts an operating environment having a control manager and controls in accordance with an embodiment of the present invention

FIG. 2 depicts a flowchart for registering a new control with a software control manager in accordance with an embodiment of the present invention.

FIG. 3 depicts a flowchart for executing an encode/decode sequence in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

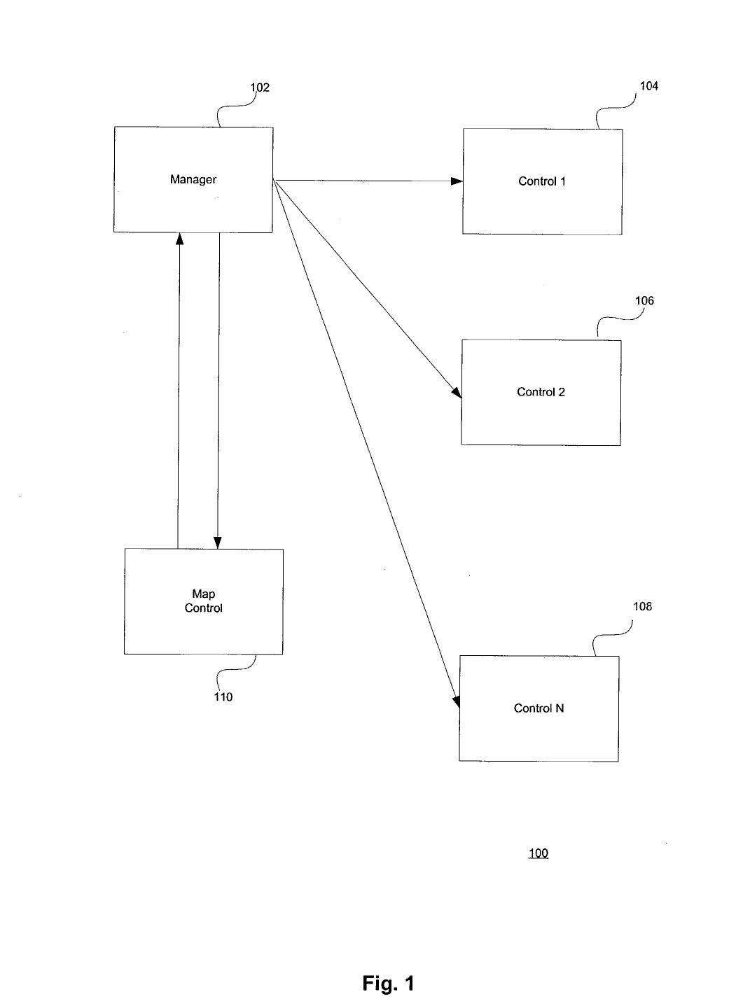

FIG. 1 depicts an operating environment 100 having a control manager 102 and controls 104, 106, 108, and 110 in accordance with an embodiment of the present invention. Operating environment 100 may reside on any computing platform that includes a processor, memory, and the means, such as software code, to execute instructions for operations on the platform. The computing platform also may be known as a unit or device that includes any computer, such as a desktop, a portable computer, a laptop, a personal digital assistant (“PDA”), and the like. The computing platform also may be a network of computers or other data exchange devices. Preferably, operating environment 100 resides on a portable computing device, such as a handheld computer that executes programs and applications.

The portable computing device may interact with a transmitter or other information storage resource to receive information that is of interest to the programs and applications on the device. Operating environment 100 may coordinate updates and data delivery to controls, programs and applications that are executing on the computing device. Further, the computing device may include proprietary information that operating environment 100 may access.

Controls 104, 106, 108, and 110 may different types of controls used to enhance programs and applications within operating environment 100. For example, if control 110 provides functionality for displaying maps on a device, then control 110 may be a map control. Further, control 104 may be a compass control, or the like. Control 104 also may be a mode control or a data control. Controls 104, 106, 108, and 110 may act as user interfaces to manipulate data stored within a memory that is accessed by a software program within operating environment 100. For example, map control 110 may interact with a user to manipulate stored maps on a hand-held device. The distinctive aspects of controls 104, 106, 108, and 110 should be their functionality as opposed to their structure. Thus, controls 104, 106, 108, and 110 are not limited in their functionality provided to operating environment 100 or the programs executing thereon. Further, the number of controls is not limited to controls 104, 106, 108 and 110. Operating environment 100 may include any number of controls, and is not limited to controls 104, 106, 108, and 110.

Operating environment 100 also includes a software control manager 102. Manager 102 recognizes and coordinates with controls 104, 106, 108, and 110 within operating environment 100. Controls 104, 106, 108, and 110 may receive information through manager 102 from operating environment 100. This information may be received on the device hosting operating environment 100, and from programs and applications executing within operating environment 100. Manager 102 also facilitates communication between controls 104, 106, 108, and 110, or any other control recognized by manager 102.

Manager 102 also recognizes and registers controls that are introduced to operating environment 100 or are enabled by programs and applications executing within operating environment 100. For example, control 108 may contact manager 102 for a designation, or name, for use within operating environment 100. Control 108 may include a string to designate the overall type of control. Manager 102 also may send a list of the controls to control 108 and their designations so that control 108 may exchange information with the other controls. Thus, within operating environment 100, controls may be aware of, and communicate with, each other.

For example, map control 110 resides within operating environment 100. Control 108 may be a compass control. Map control 110 may not need compass control 108, while compass control 108 may need map control 110 to be of any use to programs and applications within operating environment 100. If a user presses “North” on an interface provided by compass control 108, then compass control 108 would desire a map graphic to manipulate north. Subsequently, control 106 may be a macro control placed within operating environment 100. Control 106 may not be of immediate concern to map control 110, though map control 110 has been made aware of control 106 by manager 102. Manager 102 facilitates the above-disclosed relationships by receiving the initial information about controls 110, 108, and 106, and ensuring that the controls are able to exchange information with each other. Further, manager 102 confirms that compass control 108 is dependent on map control 110. The sequence of placing controls 104, 106, 108, and 110 within operating environment 100 is not a significant factor as manager 102 controls access and coordination between the controls themselves and operating environment 100. Thus, controls 104, 106, 108, and 110 may be incorporated into operating environment 100 dynamically and automatically, and without the need to become “active” to be used by resident programs and applications.

Controls 104, 106, 108, and 110 may have certain properties that provide information to manager 102. The properties may be created according to a system design, and are indicated within the controls themselves. One property may be control type. A control type may be a data string, such as “Map” or “Compass,” that denotes the overall type of the control. This property allows manager 102 to identify the control against the other controls within operating environment 100. Another property may be support members. Support members may be a string that lists the other controls that the identified control may need to use, such as compass control 108 disclosed above.

Manager 102 also implements a security or confirmation process for controls that are placed within operating environment 100. Manager 102 may invoke the security process, also known as “handshaking,” when manager 102 identifies and registers a new control within operating environment 100. Manager 102 accepts those controls that have authority and the data structure to reside within operating environment 100. If the new control does not have authority or is incompatible, then manager 102 may disable the control, place the control in a nonactive state, or delete the control from operating environment 100.

The security process may involve using a randomly generated number appended to a key string initially sent to manager 102 from the added control within operating environment 100. A string may be added to the initial key and sent back to the added control from manager 102. The modified key string may be read from the control. If the key string is not in the exact sequence desired by manager 102, then manager 102 may still allow the added control to be used, but may display a message box notifying the user or the device that an “unregistered” control is within operating environment 100. If the key is not within some allowable error range, then manager 102 may inform the added control to become benign such that the added control does not respond to other controls or operating environment 100. The user, device, or operating environment 100 may be prompted that a counterfeit, or unrecognized, control is within operating environment 100.

If manager 102 accepts the added control, then manager 102 retrieves information from the added control's data structure to facilitate communication with other controls, programs and applications within operating environment 100. For example, control 104 may remain passive within operating environment 100. If control 106 desires the functionality of control 104, then control 106 may receive the designation of control 104 from manager 102. Control 106 may store the designation within its own data structure, or may query manager 102 for control 104. Control 104, however, is not “launched” or made active in that it takes over the display or other components of the computing platform.

Problems may occur if a control is placed within operating environment 100 that is not compatible with manager 102 or the other controls. For example, control 108 may not be an e-Reusable Information Technology Environment (“eRITE”) compatible control. Before control 108 may launch, its status may be determined so that manager 102 and operating environment 100 may integrate control 108 without compromising the functionality or integrity of any functions, applications, and programs.

Manager 102 may perform a registering process on control 108 to determine its status within operating environment 100. If control 108 fails the registering process, manager 102 may notify the other controls that control 108 is not registered. The notification allows the components of operating environment 100 and a user accessing the controls to treat control 108 appropriately. An unregistered control 108 may pose several issues, including unauthorized access to a registered control, access to secure data, creation of errors due to unregistered status, use of resources within operating environment 100, and the like. Thus, manager 102 and operating environment 100 desire the controls to be registered and authorized. Further, certain unregistered controls may be allowed limited access to operating environment 100 provided these controls meet certain criteria. Most unregistered controls, however, may be shutdown and removed from operating environment 100.

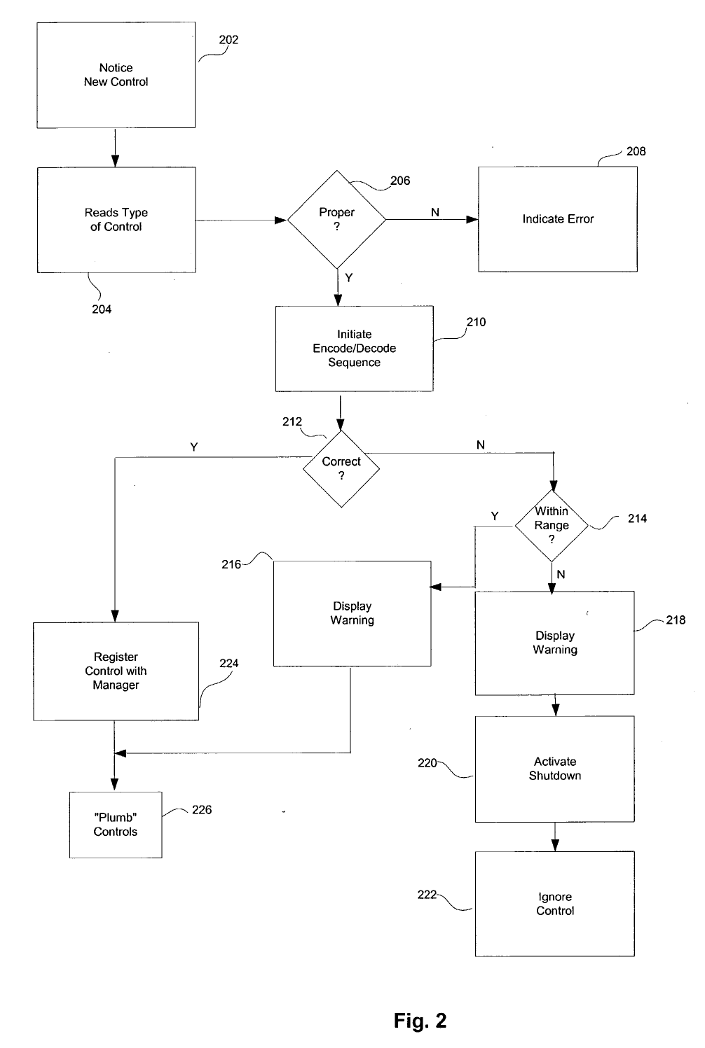

FIG. 2 depicts a flowchart for registering a new control with a software control manager in accordance with an embodiment of the present invention. As controls are placed within an operating environment, the software control manager may query and receive information from new controls to determine their status within the operating environment. The manager registers those controls that meet its criteria. Unregistered controls may be prevented from gaining access to other controls, or functioning within the operating environment.

Step 202 executes by noticing a new control within the operating environment. The new control may be prompted to notify the software control manager, or request that the control's status be determined before the control is activated. Alternatively, the operating environment may notify the manager as the control is being loaded. The new control may be placed within the operating environment by downloading the control from another location, or by accessing a memory storing the control coupled to the operating environment.

Step 204 executes by the manager reading the type of the new control. For example, if the new control is an eRITE control, the new control may notify the manager that it is an eRITE-type control. The manager also may search for specific types of controls at periodic intervals. Step 206 executes by determining whether the new control is a proper control given the new control's type. If no, then step 208 executes by indicating an error to the manager, the operating environment, the user, and the like. Additional actions may be taken with respect to the rejected control.

If step 206 is yes, then step 210 executes by initiating an encode/decode sequence between the new control and the manager. This process is disclosed in greater detail below. The encode/decode sequence produces a result from the new control that indicates that status of the new control. The encode/decode sequence may include exchanging information between the manager and the new control. The information then may be read by the manager. Step 212 executes by determining whether this information is correct. A value may be read from the new control and compared to a value within the manager. If the values match, then the response from the new control may be determined “correct.” If the values do not match, then the response may be determined “incorrect.”

If step 212 is no, then step 214 executes by determining whether the response from the new control is within an acceptable range. If parts of the response are correct, then the new control may receive limited access to the manager and the operating environment. For example, if a defined “first part” of the response is correct, then the new control may reside within the operating environment with limited capabilities. If step 214 is yes, then step 216 executes by displaying a warning to a user that an unregistered control exists. The manager may display the warning. Further, the manager may notify the operating environment and other, registered controls.

If step 214 is no, then step 218 executes by displaying a warning about an illegal control within the operating environment. If the response to the encode/decode sequence is not within the acceptable range, then the new control is illegal in that the illegal control may not enjoy any access or capability within the operating environment. The manager may display the warning. Step 220 executes by activating a shutdown property on the new control. The manager may activate the shutdown property. The shutdown property may remove the new control from any control list within the manager. Step 222 executes by ignoring the new control. The manager ignores the control.

Referring back to step 212, if the response is correct, then step 224 executes by registering the new control with the manager. The new control may be added to a control list within the manager. Step 226 executes by “plumbing” the controls within the operating environment to identify compatible controls to the manager. Further, the manager may provide information to the new control, such as references to other controls, the manager, and itself. The plumbing process may hook all the controls registered by the manager together, and may be performed real-time as controls are added.

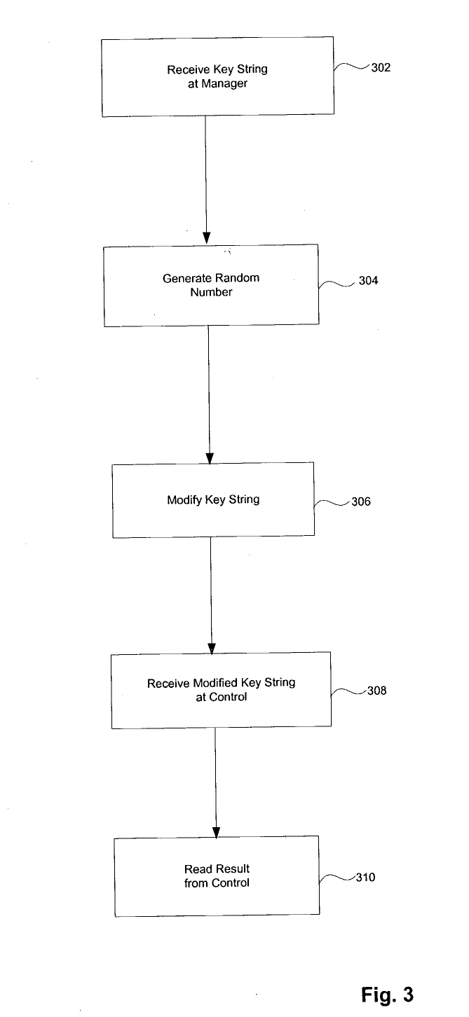

FIG. 3 depicts a flowchart for executing an encode/decode sequence in accordance with an embodiment of the present invention. FIG. 3 may correlate to step 210 of FIG. 2, but step 210 is not limited by the disclosure of FIG. 3. Step 302 executes by receiving a key string from the new control at the software control manager. The key string may be a data string particular to the new control. Step 304 executes by generating a random number at the manager. Step 306 executes by modifying the received key string with the random number. For example, the manager may add the random number to the end of the key string.

Step 308 executes by receiving the modified key string at the new control. The modified key string may be placed in a field within the new control. Step 310 executes by reading the result from the field within the new control. The manager may read the result. The new control may modify the received key string according to an algorithm within the control itself that responds to the random number sent by the manager. Alternatively, the received key string may be modified by placing the string in a field of the control already having a value. The manager reads the value to determine whether the value is correct. If the value is not within the parameters expected by the manager, the control may not be acceptable. For example, the control may not be an eRITE control.

It will be apparent to those skilled in the art that various modifications can be made in the present invention without departing from the spirit or scope of the invention. Thus, it is intended that the disclosed embodiments cover the modifications and variations of this invention provided that they come within the scope of the following claims and their equivalents.

What is claimed is:

1. A system for registering software controls within an operating environment, comprising:
a new control placed into said operating environment;
a software control manager to identify said new control; and
an encode/decode sequence to determine a type for said new control, wherein said manager authorizes said new control according to said type.

2. The system of claim 1, further comprising an old control registered with said manager, wherein said manager notifies said old control of said new control.

3. The system of claim 1, wherein said manager adds said new control to a control list.

4. The system of claim 1, wherein said new control includes a key string to send to said manager.

5. The system of claim 1, wherein said new control includes a type string to identify said new control.

6. The system of claim 1, wherein said operating environment resides on a computing platform.

7. A method for registering a control in an operating environment coupled to a memory, wherein said memory stores data, comprising:
initiating an encode/decode sequence from a manager to said control within said operating environment;
reading a result of said sequence from said control; and
allowing said control to operate within said operating environment according to said result.

8. The method of claim 7, further comprising adding said control to a control list within said manager.

9. The method of claim 7, further comprising notifying said manager of said control.

10. The method of claim 9, wherein said notifying includes sending a type string from said control to said manager.

11. The method of claim 7, further comprising determining whether said result is within an acceptable range.

12. The method of claim 11, further comprising receiving information from said manager when said result is within said range.

13. The method of claim 11, further comprising shutting down said control when said result is not within said range.

14. The method of claim 11, further comprising displaying a warning when said result is not within said range.

15. The method of claim 7, further comprising plumbing controls, including said control, within said operating environment.

16. A method for accepting a control by a control manager, comprising
receiving a key string at said manager from said control;
modifying said key string according to said manager;
receiving said modified key string at said control; and
reading said modified key string from said control.

17. The method of claim 16, wherein said modifying includes modifying said key string with a number.

18. The method of claim 17, wherein said number is a random number.

19. The method of claim 18, further comprising generating said random number.

20. The method of claim 16, further comprising modifying said modified key string at said control prior to said reading to produce a result.

21. The method of claim 20, further comprising determining whether said result is within an acceptable range.

22. The method of claim 21, further comprising registering said control if said result is within said range.

23. A method for registering a control within an operating environment, comprising;
detecting said control at a manager within said operating environment;
modifying a key string from said control at said manager;
adding said control to a control list within said manager if said modified key string is acceptable; and
plumbing other controls within said operating environment by said manager.

24. The method of claim 23, wherein said modifying includes performing an encode/decode sequence.

25. The method of claim 23, further comprising ignoring control if said modified key string is not acceptable.

26. The method of claim 23, wherein modifying includes modifying said key string with a random number.

27. The method of claim 23, further comprising modifying said modified key string at said control.

28. The method of claim 27, further comprising reading said key string from said control.
